(19) United States
(12) Patent Application Publication
(10) Pub. No.: US 2022/0014520 A1
(43) Pub. Date: Jan. 13, 2022

(54) Controlled Network Sharing for Virtual Machines

(71) Applicant: Intel Corporation, Santa Clara, CA (US)

(72) Inventors: Abhilasha Bhargav-Spantzel, Santa Clara, CA (US); Michael Glik, Kfar Saba (IL); Matan Levy, Zur Moshe (IL); Ned M. Smith, Beaverton, OR (US); Izoslav Tchigevsky, Haifa (IL)

(73) Assignee: Intel Corporation, Santa Clara, CA (US)

(21) Appl. No.: 17/483,652

(22) Filed: Sep. 23, 2021

(51) Int. Cl. H04L 29/06; G06F 9/455; H04L 12/24

(52) U.S. Cl. CPC H04L 63/0876; G06F 9/45558; G06F 2009/45595; H04L 41/0806; H04L 63/1425

(57) ABSTRACT

Systems and methods for a host device to mediate access by virtual machines executing on the host device to network connections of the host device based on characteristic of the network connection and on a per virtual machine basis are provided. The host device can execute a root partition or operating system and can include a switch to mediate connection between individual virtual switches of the virtual machines and the network stack of the root partition.

### BACKGROUND

Virtual machines are often used in modern computing systems to segregate computing tasks and/or data and to increase efficiency of resource utilization. Network connections, such as, Wi-Fi network connections of a host device can be shared across virtual machines using a virtual switch. The virtual switch definition in each virtual machine is statically mapped to the network connection of the host device. Accordingly, the virtual switch will have an active network connection provided that the host device has an active network connection.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a system 100 for individually controlling access of virtual machines to a host network connection.

FIG. 2 illustrates a logic flow 200 for individually controlling access of virtual machines to a host network connection.

FIG. 3 illustrates a system 300 for individually controlling access of virtual machines to a host network connection.

FIG. 4 illustrates a logic flow 400 for individually controlling access of virtual machines to a host network connection.

FIG. 5 illustrates a computer-readable storage medium 500 for individually controlling access of virtual machines to a host network connection.

FIG. 6 illustrates a communication architecture 600.

FIG. 7 illustrates a system 700.

### DETAILED DESCRIPTION

The present disclosure is generally directed to defining authorized network connections of the host device at the virtual machine (VM) level and per VM. For example, the host device may have multiple wired and/or wireless networks with which is connects. The present disclosure provides a virtual switch bridge controller than defines access parameters for each of the multiple networks of the host device on a per VM basis.

As a specific example, a hospital may deploy two wireless networks, one for mission critical (e.g., telemetry for life saving equipment, or the like) traffic and another for non-mission critical traffic. On a particular computing device multiple VMs may be provisioned. One of these VMs may run mission critical applications that are allowed to use the mission critical wireless network while another VM may run non-mission critical applications that should not use the mission critical wireless network. Conventional systems would provide that both VMs would access whatever wireless network, even the mission critical wireless network, is connected to or available to the host device.

The present disclosure provides virtual switch bridge controller than extends the network connection manager of the host device to the VMs. Accordingly, where a network that is not authorized for a particular VM is not connected to the host device, the virtual switch will appear disconnected to that particular VM, even where another network connection is active or available to the host device.

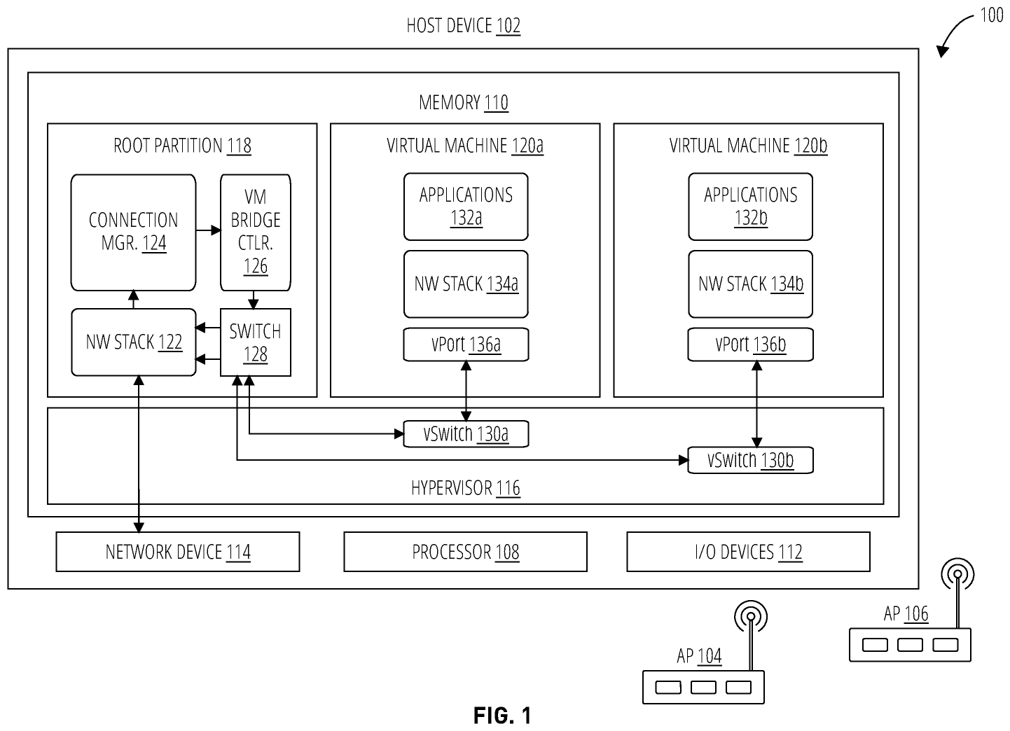

FIG. 1 illustrates a system 100, in accordance with non-limiting example(s) of the present disclosure. System 100 includes a host device 102 and multiple network access points. In particular, system 100 is depicted including network access point 104 and network access point 106. In general, host device 102 is arranged to access a network (e.g., the Internet, an intranet, or the like) via network access point 104 and/or network access point 106. It is important to note that network access point 104 and network access point 106 are access points to different networks. These networks can be differentiated by a number of characteristics, such as, ownership, network name, authentication strength, security protocols, etc.

Host device 102 includes a processor 108, memory 110, input and/or output devices 112, and network device 114. The processor 108 and the memory 110 may comprise logic, circuitry, interfaces and/or processor executable instructions (or “code”) that may enable processing of data and/or controlling of operations for host device 102. The processor 108 may comprise, for example, an x86 based CPU, an ARM, or an application specific integrated circuit (ASIC). The memory 110 may comprise, for example, SRAM and/or DRAM that stores data and/or instructions. The memory 110 may be implemented in a memory device (e.g., a hard drive, a solid state device, or the like).

The processor 108, utilizing the memory 110, may be operable to execute one or more operating systems (e.g., root partition 118) and/or VMs (e.g., virtual machine 120a, 120b, etc.) and may further be operable to execute a hypervisor 116, which is arranged to manage the operation of the any host operating systems (e.g., root partition 118) and VMs (e.g., virtual machine 120a, virtual machine 120b, etc.).

In general, the present disclosure provides to mediate or control access to network access point 104 and network access point 106 at the VM level, for example, per virtual machine 120a and virtual machine 120b. It is noted that only two (2) VMs (e.g., virtual machines 120a and 120b) are depicted as being hosted by host device 102. However, the present disclosure can be provided to mediate access to network connections for more than two (2) VMs. Examples are not limited in this context.

Virtual machines 120a and virtual machine 120b may include an operating system (OS) (not shown) that can support execution, by processor 108, of applications, a network stack (NW stack), and a virtual port (vPort). In particular, virtual machine 120a includes applications 132a, NW stack 134a, and vPort 136a while virtual machine 120b includes applications 132b, NW stack 134b, and vPort 136b. Hypervisor 116 includes software switches (vSwithes), such as, vSwitch 130a and vSwitch 130b, which provide network connectivity for the virtual machines 120a and 120b. Accordingly, during operation, applications (e.g., applications 132a and 132b) can access networks via network device 114 and network access point 104 or network access point 106 through respective NW stacks, vPorts, and vSwitches. In particular, applications 132a can access a network through 114 and network access point 104 or network access point 106 via NW stack 134a, vPort 136a, and vSwitch 130a while applications 132b can access a network through 114 and network access point 104 or network access point 106 via NW stack 134b, vPort 136b, and vSwitch 130b.

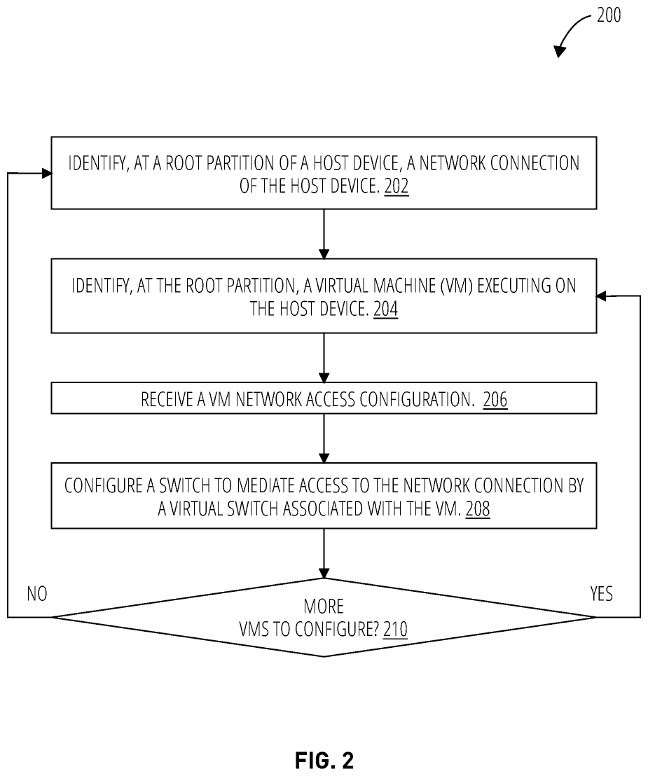

The root partition 118 includes a NW stack 122 coupled to network device 114 and arranged to provide network access to virtual machine 120a and virtual machine 120b. Root partition 118 further includes connection manager 124, VM bridge controller 126, and switch 128. These components are further described in detail below (refer to FIG. 2). However, in general, they are configured to mediate or control access, per VM (e.g., virtual machine 120a, virtual machine 120b, etc.) to NW stack 122, network device 114, and ultimately to network access point 104 and network access point 106.

Network device 114 may comprise logic, circuitry, interfaces, and/or code that may be operable to transmit and receive data in adherence with one or more networking standards. For example, network device 114 may implement physical layer functions, data link layer functions, network interface layer functions, Internet layer functions, and, in some instances, transport layer functions and application layer functions. The network device 114 may, for example, communicate in adherence with one or more Ethernet standards defined in IEEE 802. The network device 114 may be enabled to utilize virtualization such that it may present itself to the hypervisor 116 and/or to an external device (e.g., network access point 104, network access point 106, etc.) as multiple network devices.

The input and/or output devices 112 may comprise logic, circuitry, interfaces, and/or code that may be operable to, for example, communicate information between various components of the host device 102. The input and/or output devices 112 may comprise one or more standardized busses and one or more bus controllers. Accordingly, the input and/or output devices 112 may be operable to identify devices on the bus, enumerate devices on the bus, allocate and de-allocate resources for various devices on the bus, and/or otherwise manage communications on the bus. For example, the input and/or output devices 112 may be a PCIe system and may comprise a PCIe root complex and one or more PCIe switches and/or bridges. In some instances, the input and/or output devices 112 may be controlled by the hypervisor 116.

FIG. 2 illustrates a logic flow 200 that can be implemented by a host device executing a number of VMs to mediate access by the VMs to network connections of the host device. In particular, logic flow 200 can be implemented to mediate access to the network connections on a per VM basis based on characteristics of the network connection. With some examples, logic flow 200 can be implemented by host device 102 of system 100 to mediate access to networks of network access point 104 and network access point 106 by virtual machines 120a and 120b on an individual VM level and per network access connection.

Logic flow 200 can begin at block 202. At block 202 “identify, at a root partition of a host device, a network connection of the host device” a network connection of a host device can be identified by a root partition (or host partition) of the host device. For example, root partition 118 can identify a network connection associated with either network access point 104 or network access point 106 at block 202. More specifically, processor 108 can execute connection manager 124 to identify a network connection available to NW stack 122. In some examples, the network connection can be a newly established network connection. In other examples, the identified network connection can be a reconnection to a previously established network connection.

Continuing to block 204 “identify, at the root partition, a virtual machine (VM) executing on the host device” a VM executing on the host device can be identified by the root partition. For example, root partition 118 can identify one of virtual machine 120a or virtual machine 120b executing on host device 102. In particular, processor 108 can execute connection manager 124 to identify one of the VMs executing on host device 102. Continuing to block 206 “receive a VM network access configuration” a VM network access configuration can be received. For example, VM bridge controller 126 can store (e.g., in memory circuitry, or the like) indications of a VM network access configuration. In general, the VM network access configuration can include indications of VMs executing on host device 102 (e.g., virtual machine 120a, virtual machine 120b, etc.) as well as network connections available to host device 102 (e.g., network connection associated with network access point 104, network connection associated with network access point 106, etc.). Further, the VM network access configuration can include, for each VM and network connection, an indication of whether the particular VM is allowed to access the particular network. The following table provides a very specific example of a VM network access configuration, which can be stored in VM bridge controller 126 and arranged to indicate access privileges for VMs executing on host device 102.

| Network | Network | VM 1 (e.g., | VM 2 (e.g., |
|---|---|---|---|
| Connection | Connection | virtual machine | virtual machine |
| Name | Characteristics | 120a) | 120b) |
| Network 1 (e.g., | SS ID name | allowed | not allowed |
| network access | | | |
| point 104) | | | |
| Network 2 (e.g., | SS ID name | not allowed | allowed |
| network access | | | |
| point 106) | | | |
| Unsecured | Security | not allowed | allowed |
| Network | protocols | | |

As indicated in the table above, network connections can be referenced or identified by a number of characteristics (e.g., SSID, security protocols, etc.). Likewise, for each network connection an access privilege for each VM is indicated. For example, the table above indicates that virtual machine 120a is allowed to access network connections associated with network access point 104 but not network access point 106 while virtual machine 120b is allowed to access network connections associated with network access point 106 but not network access point 104.

Continuing to block 208″configure a switch to mediate access to the network connection by a virtual switch associated with the VM″ a switch to mediate access to the network connection by a virtual switch associated with the VM is configured. For example, processor 108 can execute VM bridge controller 126 to configure switch 128 to mediate (e.g., turn off, turn on, etc.) access to NW stack 122 and network device 114 by the one of the vSwitches 130a or 130b.

Continuing to decision block 210 “more VMs to configure?” a determination can be made if there are more VMs to configure. For example, processor 108 can execute processor 108 can execute connection manager 124 to determine whether all VMs (e.g., virtual machine 120a, virtual machine 120b, etc.) have been configured. From decision block 210, logic flow 200 can return to block 202 or can return to block 204. In particular, logic flow 200 can return to block 204 from decision block 210 based on a determination that there are more VMs to configure while logic flow 200 can return to block 202 after decision block 210 based on a determination that there are not more VMs to configure. As such, logic flow 200 provides that where host device 102 associates with a network (e.g., via network access point 104, via network access point 106, or the like) the VMs (e.g., virtual machine 120a and 120b) executing on the host device can be configured for access to the network based on configuration. It is noted that at block 202, logic flow 200 can detect new network connections, network re-connections, new virtual switches being provisioned and configures the VM and associated virtual switch to either be connected to the network (or not) via switch 128.

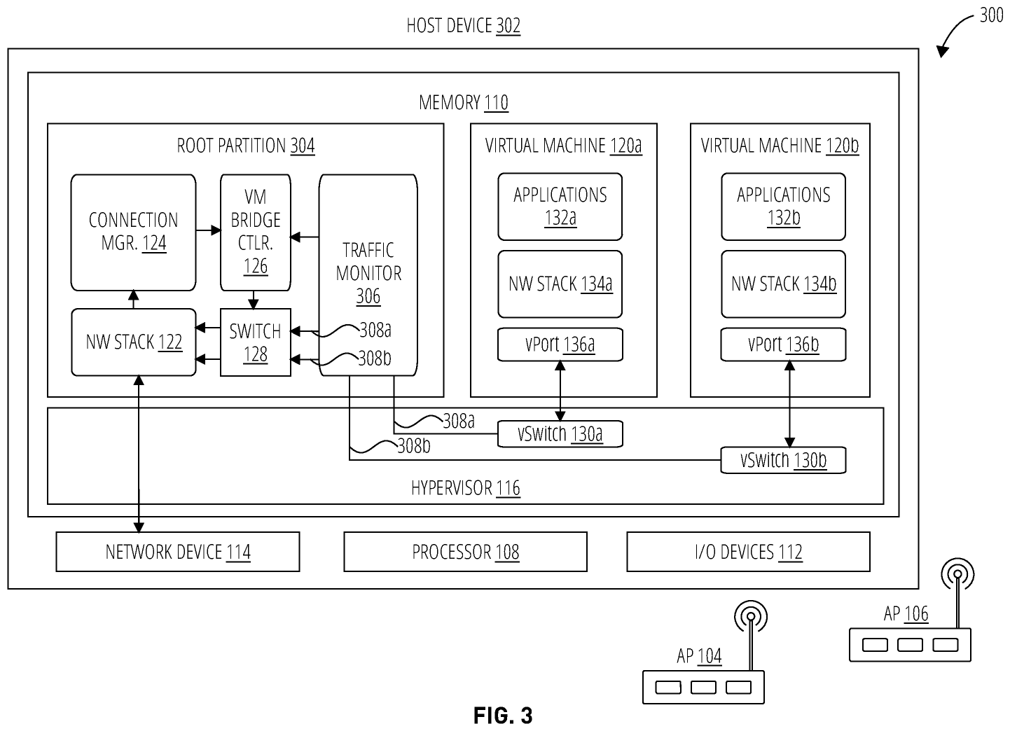

FIG. 3 illustrates a system 300, in accordance with non-limiting example(s) of the present disclosure. System 300, like system 100 of FIG. 1, includes a host device arranged to mediate access to network connections of VMs executing on the host device. For example, system 300 includes host device 302 and network access points 104 and 106. Host device 302 is arranged to access a network (e.g., the Internet, an intranet, or the like) via network access point 104 and/or network access point 106.

Host device 302 includes processor 108, memory 110, input and/or output devices 112, and network device 114. In host device 302, the processor 108, utilizing the memory 110, may be operable to execute one or more operating systems (e.g., root partition 304) and/or VMs (e.g., virtual machine 120a, 120b, etc.) and may further be operable to execute a hypervisor 116, which is arranged to manage the operation of the any host operating systems (e.g., root partition 304) and VMs (e.g., virtual machine 120a, virtual machine 120b, etc.).

Root partition 304 is similar to root partition 118 with the exception that root partition 304 includes traffic monitor 306 arranged to monitor data communicated to and from the VMs by way of the network device 114. For example, traffic monitor 306 can be communicatively coupled to vSwitch 130a and vSwitch 130a to switch 128 such that traffic monitor 306 can inspect data path 308a and data path 308b. For example, traffic monitor 306 can inspect packets, messages, or the like transmitted and/or received by virtual machine 120a and virtual machine 120a via data paths 308a and 308b. It is noted that although traffic monitor 306 is depicted as being executed and supported by root partition 118, in some examples, traffic monitor 306 can be implemented by the hypervisor 116.

The present disclosure provides that access to a network connection (e.g., via network device 114) can be disconnected by traffic monitor 306. For example, traffic monitor 306 can implemented intrusion detection or suspicious traffic algorithms such that where suspicion activity on a particular data path (e.g., data path 308a, or the like) that switch 128 can be configured to disconnect that particular data path from the NW stack 122 and network device 114.

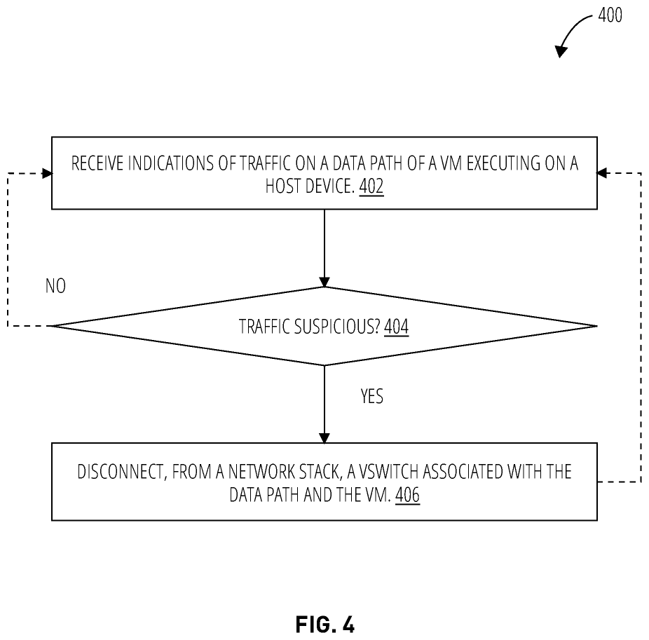

FIG. 4 illustrates a logic flow 400 that can be implemented by a host device executing a number of VMs to monitor traffic of the VMs and mediate access by the VMs to network connections of the host device based on the monitored traffic. In particular, logic flow 400 can be implemented to mediate access to the network connections on a per VM basis based on characteristics of the network connection and/or monitored traffic on data paths associated with the VMs. With some examples, logic flow 400 can be implemented by host device 302 of system 300 to mediate access to networks of network access point 104 and network access point 106 by virtual machines 120a and 120b on an individual VM level based on traffic patterns on data paths associated with the VMs.

Logic flow 400 can begin at block 402. At block 402 “receive indications of traffic on a data path of a VM executing on a host device” an indication of traffic patterns on a data path associated with a VM executing on a host device can be received. For example, processor 108 can execute traffic monitor 306 to cause traffic monitor 306 to receive indications of traffic on data path 308a and/or data path 308b.

Continuing to decision block 404 “traffic suspicious?” a determination as to whether the traffic is suspicious can be made. For example, processor 108 can execute traffic monitor 306 to determine whether the traffic on data paths 308a and/or data path 308b (e.g., based on indications received at block 402) is suspicious. For example, processor 108 can execute traffic monitor 306 to implement a traffic pattern monitoring algorithm. It is noted that a variety of algorithms for monitoring traffic are available and the present disclosure is not limited to a particular type or class of such algorithms. However, the present disclosure provides novel structure in the switch 128 and traffic monitor 306 configuration such that a data path to a particular VM (e.g., data path 308a and virtual machine 120a) or the like) can be disconnected based on monitored traffic on the data path.

From decision block 404, logic flow 400 can continue to block 406 or end (or optionally return to block 402). In particular, logic flow 400 can continue from decision block 404 to block 406 based on a determination that the traffic on the data path is suspicious while logic flow 400 can end (or return to block 402) based on a determination that the traffic on the data path is not suspicious. For example, where no suspicious traffic is detected, logic flow 400 can return to block 402 to monitor another data path, or continue monitoring the same data path.

At block 406 “disconnect, from a network stack, a vSwitch associated with the data path and the VM” a vSwitch associated with the VM and the monitored data path can be disconnected from a network stack and network device of the host device. For example, processor 108 can execute traffic monitor 306 to alert VM bridge controller 126 that suspicious traffic is detected. Processor 108 can further execute VM bridge controller 126 to configure switch 128 to disconnect the data path (e.g., data path 308a, or the like) from NW stack 122 and network device 114.

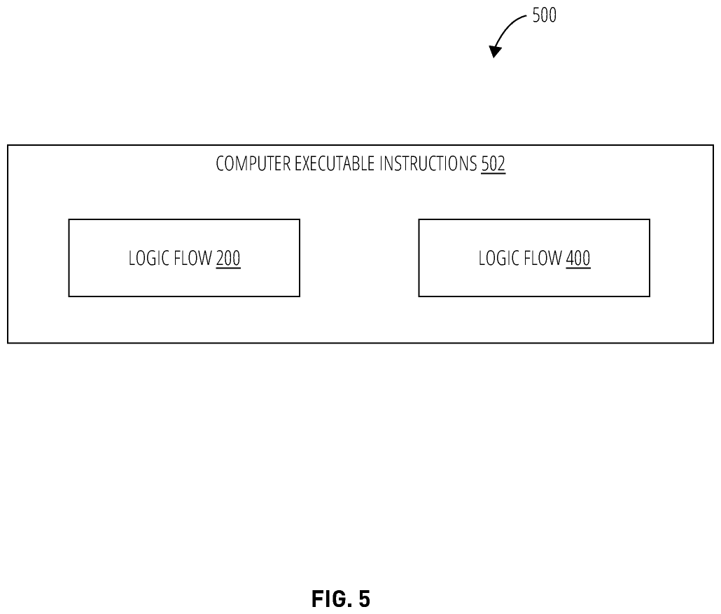

FIG. 5 illustrates computer-readable storage medium 500. Computer-readable storage medium 500 may comprise any non-transitory computer-readable storage medium or machine-readable storage medium, such as an optical, magnetic or semiconductor storage medium. In various embodiments, computer-readable storage medium 500 may comprise an article of manufacture. In some embodiments, computer-readable storage medium 500 may store computer executable instructions 502 with which circuitry (e.g., processor 108, or the like) can execute. For example, computer executable instructions 502 can include instructions to implement operations described with respect to logic flow 200 and/or logic flow 400. Examples of computer-readable storage medium 500 or machine-readable storage medium may include any tangible media capable of storing electronic data, including volatile memory or non-volatile memory, removable or non-removable memory, erasable or non-erasable memory, writeable or re-writeable memory, and so forth. Examples of computer executable instructions 502 may include any suitable type of code, such as source code, compiled code, interpreted code, executable code, static code, dynamic code, object-oriented code, visual code, and the like.

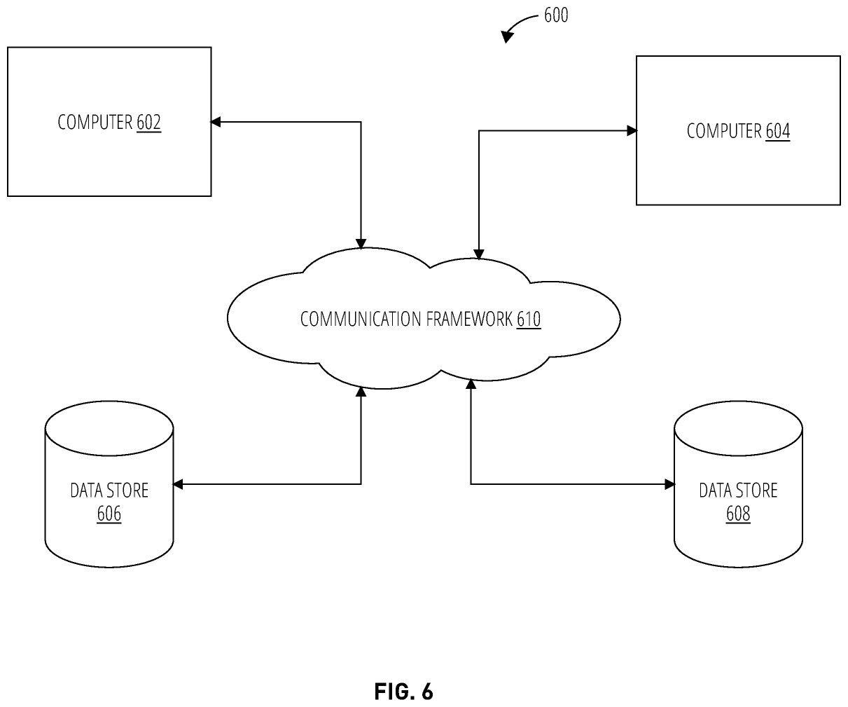

FIG. 6 illustrates an exemplary communication architecture 600 suitable for implementing various embodiments. For example, one or more computing devices may communicate with each other via a communication framework 610, which may be a network implemented to facilitate electronic communication between devices. The communication architecture 600 includes various common communications elements, such as a transmitter, receiver, transceiver, radio, network interface, baseband processor, antenna, amplifiers, filters, power supplies, and so forth. System 100, and particularly host device 102 as well as system 300 and host device 302 can communicate in a fashion like communication architecture 600. For example, virtual machine 120a and/or virtual machine 120b can communicate using communication architecture 600. The present disclosure can be provided to mediate access by virtual machine 120a and/or virtual machine 120b to communication paths of communication architecture 600.

As shown in this figure, the communication architecture 600 includes a computer 602 and a computer 604, which are operatively connected to one or more respective data stores, such as, data store 606 and/or data store 608. Data store 606 and data store 608 can be employed to store information local to the respective computers (e.g., computer 602, computer 604, etc.), such as cookies and/or associated contextual information.

Computer 602 and computer 604 may communicate information between each other using a communication framework 610. Computer 602 and computer 604 may provide time synchronization as part of communicating information between each other using communication framework 610. In one example, computer 602 may be implemented or configured in an RSU, and further, computer 604 may be implemented or configured in a vehicle. The communication framework 610 may implement any well-known communications techniques and protocols. The communication framework 610 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communication framework 610 may implement various network interfaces arranged to accept, communicate, and connect to a communications network. A network interface may be regarded as a specialized form of an input/output (I/O) interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.7a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by computer 602 and computer 604. Communication framework 610 may be any one or combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

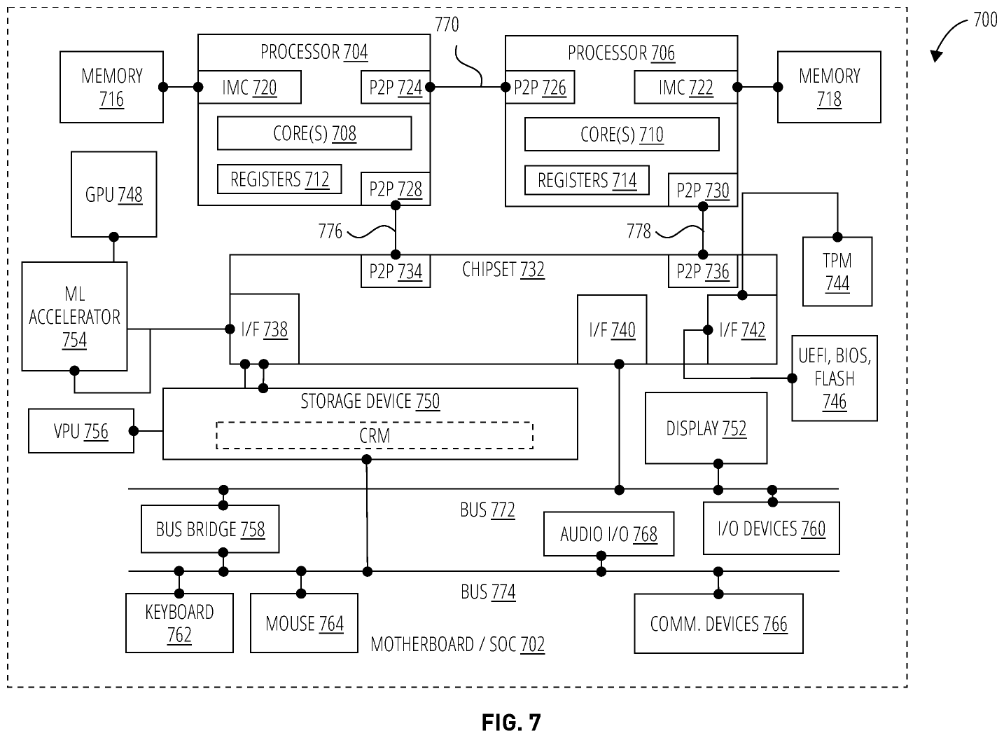

FIG. 7 illustrates an embodiment of a system 700. System 700 is a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, handheld device such as a personal digital assistant (PDA), or other device for processing, displaying, or transmitting information. Similar embodiments may comprise, e.g., entertainment devices such as a portable music player or a portable video player, a smart phone or other cellular phone, a telephone, a digital video camera, a digital still camera, an external storage device, or the like. Further embodiments implement larger scale server configurations. In other embodiments, the system 700 may have a single processor with one core or more than one processor. Note that the term “processor” refers to a processor with a single core or a processor package with multiple processor cores. In at least one embodiment, the computing system 700 is representative of the components of the system 100 or system 300. More generally, the computing system 700 is configured to implement all logic, systems, logic flows, methods, apparatuses, and functionality described herein with reference to FIG. 1 to FIG. 4. For example host device 102 or host device 302 can be like system 700.

As used in this application, the terms “system” and “component” and “module” are intended to refer to a computer-related entity, either hardware, a combination of hardware and software, software, or software in execution, examples of which are provided by the exemplary system 700. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

As shown in this figure, system 700 comprises a motherboard or system-on-chip (SoC) 702 for mounting platform components. Motherboard or system-on-chip (SoC) 702 is a point-to-point (P2P) interconnect platform that includes a first processor 704 and a second processor 706 coupled via a point-to-point interconnect 770 such as an Ultra Path Interconnect (UPI). In other embodiments, the system 700 may be of another bus architecture, such as a multi-drop bus. Furthermore, each of processor 704 and processor 706 may be processor packages with multiple processor cores including core(s) 708 and core(s) 710, respectively. While the system 700 is an example of a two-socket (2S) platform, other embodiments may include more than two sockets or one socket. For example, some embodiments may include a four-socket (4S) platform or an eight-socket (8S) platform. Each socket is a mount for a processor and may have a socket identifier. Note that the term platform refers to the motherboard with certain components mounted such as the processor 704 and chipset 732. Some platforms may include additional components and some platforms may only include sockets to mount the processors and/or the chipset. Furthermore, some platforms may not have sockets (e.g. SoC, or the like).

The processor 704 and processor 706 can be any of various commercially available processors, including without limitation an Intel® Celeron®, Core®, Core (2) Duo®, Itanium®, Pentium®, Xeon®, and XScale® processors; AMD® Athlon®, Duron® and Opteron® processors; ARM® application, embedded and secure processors; IBM® and Motorola® DragonBall® and PowerPC® processors; IBM and Sony® Cell processors; and similar processors. Dual microprocessors, multi-core processors, and other multi processor architectures may also be employed as the processor 704 and/or processor 706. Additionally, the processor 704 need not be identical to processor 706.

Processor 704 includes registers 712, integrated memory controller (IMC) 720, and point-to-point (P2P) interface 724 and P2P interface 728. Similarly, the processor 706 includes registers 714, IMC 722, as well as P2P interface 726 and P2P interface 730. IMC 720 and IMC 722 couple the processor 704 and processor 706, respectively, to respective memories (e.g., memory 716 and memory 718). Memory 716 and memory 718 may be portions of the main memory (e.g., a dynamic random-access memory (DRAM)) for the platform such as double data rate type 3 (DDR3) or type 4 (DDR4) synchronous DRAM (SDRAM). In the present embodiment, the memory 716 and memory 718 locally attach to the respective processors (i.e., processor 704 and processor 706). In other embodiments, the main memory may couple with the processors via a bus and shared memory hub.

System 700 includes chipset 732 coupled to processor 704 and processor 706. Furthermore, chipset 732 can be coupled to storage device 750, for example, via an interface (I/F) 738. The I/F 738 may be, for example, a Peripheral Component Interconnect-enhanced (PCI-e). Storage device 750 can store instructions executable by circuitry of system 700 (e.g., processor 704, processor 706, GPU 748, ML accelerator 754, vision processing unit 756, or the like). For example, storage device 750 can store instructions for computer-readable storage medium 500, or the like.

Processor 704 couples to a chipset 732 via P2P interface 728 and P2P 734 while processor 706 couples to a chipset 732 via P2P interface 730 and P2P 736. Direct media interface (DMI) 776 and DMI 778 may couple the P2P interface 728 and the P2P 734 and the P2P interface 730 and P2P 736, respectively. DMI 776 and DMI 778 may be a high-speed interconnect that facilitates, e.g., eight Giga Transfers per second (GT/s) such as DMI 3.0. In other embodiments, the processor 704 and processor 706 may interconnect via a bus.

The chipset 732 may comprise a controller hub such as a platform controller hub (PCH). The chipset 732 may include a system clock to perform clocking functions and include interfaces for an I/O bus such as a universal serial bus (USB), peripheral component interconnects (PCIs), serial peripheral interconnects (SPIs), integrated interconnects (I2Cs), and the like, to facilitate connection of peripheral devices on the platform. In other embodiments, the chipset 732 may comprise more than one controller hub such as a chipset with a memory controller hub, a graphics controller hub, and an input/output (I/O) controller hub.

In the depicted example, chipset 732 couples with a trusted platform module (TPM) 744 and UEFI, BIOS, FLASH circuitry 746 via I/F 742. The TPM 744 is a dedicated microcontroller designed to secure hardware by integrating cryptographic keys into devices. The UEFI, BIOS, FLASH circuitry 746 may provide pre-boot code.

Furthermore, chipset 732 includes the I/F 738 to couple chipset 732 with a high-performance graphics engine, such as, graphics processing circuitry or a graphics processing unit (GPU) 748. In other embodiments, the system 700 may include a flexible display interface (FDI) (not shown) between the processor 704 and/or the processor 706 and the chipset 732. The FDI interconnects a graphics processor core in one or more of processor 704 and/or processor 706 with the chipset 732.

Additionally, ML accelerator 754 and/or vision processing unit 756 can be coupled to chipset 732 via I/F 738. ML accelerator 754 can be circuitry arranged to execute ML related operations (e.g., training, inference, etc.) for ML models. Likewise, vision processing unit 756 can be circuitry arranged to execute vision processing specific or related operations. In particular, ML accelerator 754 and/or vision processing unit 756 can be arranged to execute mathematical operations and/or operands useful for machine learning, neural network processing, artificial intelligence, vision processing, etc.

Various I/O devices 760 and display 752 couple to the bus 772, along with a bus bridge 758 which couples the bus 772 to a second bus 774 and an I/F 740 that connects the bus 772 with the chipset 732. In one embodiment, the second bus 774 may be a low pin count (LPC) bus. Various devices may couple to the second bus 774 including, for example, a keyboard 762, a mouse 764 and communication devices 766.

Furthermore, an audio I/O 768 may couple to second bus 774. Many of the I/O devices 760 and communication devices 766 may reside on the motherboard or system-on-chip (SoC) 702 while the keyboard 762 and the mouse 764 may be add-on peripherals. In other embodiments, some or all the I/O devices 760 and communication devices 766 are add-on peripherals and do not reside on the motherboard or system-on-chip (SoC) 702.

The following examples pertain to further embodiments, from which numerous permutations and configurations will be apparent.

Example 1. A method, comprising: identifying, at a root partition of a host device, a network connection of the host device; identifying, at the root partition, a virtual machine (VM) executing on the host device; receiving a VM network access configuration; and configuring a switch to communicatively connect or disconnect a virtual switch (vSwitch) associated with the VM with the network connection of the host device.

Example 2. The method of example 1, the VM a first VM and the vSwitch a first vSwitch, the method comprising: identifying, at the root partition, a second VM executing on the host device; and configuring the switch to communicatively connect or disconnect a second vSwitch associated with the second VM with the network connection of the host device independently of the first vSwitch.

Example 3. The method of example 2, configuring the switch to communicatively connect or disconnect the first vSwitch associated with the first VM with the network connection of the host device comprising: determining whether the first VM is authorized to access the network connection of the host device based on the VM network access configuration; and configuring the switch to communicatively connect the first vSwitch with the network connection of the host device based on a determination that the first VM is authorized to access the network connection of the host device; or configuring the switch to communicatively disconnect the first vSwitch with the network connection of the host device based on a determination that the first VM is not authorized to access the network connection of the host device.

Example 4. The method of example 3, configuring the switch to communicatively connect or disconnect the second vSwitch associated with the second VM with the network connection of the host device comprising: determining whether the second VM is authorized to access the network connection of the host device based on the VM network access configuration; and configuring the switch to communicatively connect the second vSwitch with the network connection of the host device based on a determination that the second VM is authorized to access the network connection of the host device; or configuring the switch to communicatively disconnect the second vSwitch with the network connection of the host device based on a determination that the second VM is not authorized to access the network connection of the host device.

Example 5. The method of example 4, determining whether the first VM is authorized to access the network connection of the host device based on the VM network access configuration comprising: identifying a characteristic of the network connection of the host device; and determining whether the first VM is authorized to access the network connection of the host device based on the identified characteristic of the network connection.

Example 6. The method of example 4, wherein the first vSwitch and the second vSwitch are communicatively connected to the network connection of the host device, the method comprising: monitoring network traffic on a first data path between the first vSwitch and the switch; monitoring network traffic on a second data path between the second vSwitch and the switch; determining whether network traffic on the first data path matches one or more suspicious network traffic pattern; determining whether the network traffic on the second data path matches one or more suspicious network traffic pattern; and configuring the switch to disconnect the first vSwitch based on a determination that the network traffic on the first data path matches the one or more suspicious network traffic patterns; configuring the switch to disconnect the second vSwitch based on a determination that the network traffic on the second data path matches the one or more suspicious network traffic patterns; or configuring the switch to disconnect both the first vSwitch and the second vSwitch based on a determination that the network traffic on the first data path and the network traffic on the second data path matches the one or more suspicious network traffic patterns.

Example 7. The method of example 1, wherein the vSwitch is communicatively connected to the network connection of the host device, the method comprising: monitoring network traffic on a data path between the vSwitch and the switch; determining whether network traffic matches one or more suspicious network traffic pattern; and configuring the switch to disconnect the vSwitch from the network connection based on a determination that the network traffic matches the one or more suspicious network traffic patterns.

Example 8. A computing apparatus comprising: a processor of a host device; and memory at the host device storing instructions that, when executed by the processor, configure the host device to: identify, at a root partition of the host device, a network connection of the host device; identify, at the root partition, a virtual machine (VM) executing on the host device; receive a VM network access configuration; and configure a switch to communicatively connect or disconnect a virtual switch (vSwitch) associated with the VM with the network connection of the host device.

Example 9. The computing apparatus of example 8, the VM a first VM and the vSwitch a first vSwitch, the instructions when executed by the processor configured the host device to: identify, at the root partition, a second VM executing on the host device; and configure the switch to communicatively connect or disconnect a second vSwitch associated with the second VM with the network connection of the host device independently of the first vSwitch.

Example 10. The computing apparatus of example 9, the instructions when executed by the processor configured the host device to: determine whether the first VM is authorized to access the network connection of the host device based on the VM network access configuration; and configure the switch to communicatively connect the first vSwitch with the network connection of the host device based on a determination that the first VM is authorized to access the network connection of the host device; or configure the switch to communicatively disconnect the first vSwitch with the network connection of the host device based on a determination that the first VM is not authorized to access the network connection of the host device.

Example 11. The computing apparatus of example 10, the instructions when executed by the processor configured the host device to: determine whether the second VM is authorized to access the network connection of the host device based on the VM network access configuration; and configure the switch to communicatively connect the second vSwitch with the network connection of the host device based on a determination that the second VM is authorized to access the network connection of the host device; or configure the switch to communicatively disconnect the second vSwitch with the network connection of the host device based on a determination that the second VM is not authorized to access the network connection of the host device.

Example 12. The computing apparatus of example 11, the instructions when executed by the processor configured the host device to: identify a characteristic of the network connection of the host device; and determine whether the first VM is authorized to access the network connection of the host device based on the identified characteristic of the network connection.

13. The computing apparatus of example 11, wherein the first vSwitch and the second vSwitch are communicatively connected to the network connection of the host device, the instructions when executed by the processor configured the host device to: monitor network traffic on a first data path between the first vSwitch and the switch; monitor network traffic on a second data path between the second vSwitch and the switch; determine whether network traffic on the first data path matches one or more suspicious network traffic pattern; determine whether the network traffic on the second data path matches one or more suspicious network traffic pattern; and configure the switch to disconnect the first vSwitch based on a determination that the network traffic on the first data path matches the one or more suspicious network traffic patterns; configure the switch to disconnect the second vSwitch based on a determination that the network traffic on the second data path matches the one or more suspicious network traffic patterns; or configure the switch to disconnect both the first vSwitch and the second vSwitch based on a determination that the network traffic on the first data path and the network traffic on the second data path matches the one or more suspicious network traffic patterns.

Example 14. The computing apparatus of example 8, wherein the vSwitch is communicatively connected to the network connection of the host device, the instructions when executed by the processor configured the host device to: monitor network traffic on a data path between the vSwitch and the switch; determine whether network traffic matches one or more suspicious network traffic pattern; and configure the switch to disconnect the vSwitch from the network connection based on a determination that the network traffic matches the one or more suspicious network traffic patterns.

Example 15. A non-transitory computer-readable storage medium, the computer-readable storage medium including instructions that when executed by circuitry of a host device, cause the host device to: identify, at a root partition of the host device, a network connection of the host device; identify, at the root partition, a virtual machine (VM) executing on the host device; receive a VM network access configuration; and configure a switch to communicatively connect or disconnect a virtual switch (vSwitch) associated with the VM with the network connection of the host device.

Example 16. The computer-readable storage medium of example 15, the VM a first VM and the vSwitch a first vSwitch, the instructions when executed by the circuitry cause the host device to: identify, at the root partition, a second VM executing on the host device; and configure the switch to communicatively connect or disconnect a second vSwitch associated with the second VM with the network connection of the host device independently of the first vSwitch.

Example 17. The computer-readable storage medium of example 16, the instructions when executed by the circuitry cause the host device to: determine whether the first VM is authorized to access the network connection of the host device based on the VM network access configuration; and configure the switch to communicatively connect the first vSwitch with the network connection of the host device based on a determination that the first VM is authorized to access the network connection of the host device; or configure the switch to communicatively disconnect the first vSwitch with the network connection of the host device based on a determination that the first VM is not authorized to access the network connection of the host device.

Example 18. The computer-readable storage medium of example 17, the instructions when executed by the circuitry cause the host device to: determine whether the second VM is authorized to access the network connection of the host device based on the VM network access configuration; and configure the switch to communicatively connect the second vSwitch with the network connection of the host device based on a determination that the second VM is authorized to access the network connection of the host device; or configure the switch to communicatively disconnect the second vSwitch with the network connection of the host device based on a determination that the second VM is not authorized to access the network connection of the host device.

Example 19. The computer-readable storage medium of example 18, the instructions when executed by the circuitry cause the host device to: identify a characteristic of the network connection of the host device; and determine whether the first VM is authorized to access the network connection of the host device based on the identified characteristic of the network connection.

Example 20. The computer-readable storage medium of example 18, wherein the first vSwitch and the second vSwitch are communicatively connected to the network connection of the host device, the instructions when executed by the circuitry cause the host device to: monitor network traffic on a first data path between the first vSwitch and the switch; monitor network traffic on a second data path between the second vSwitch and the switch; determine whether network traffic on the first data path matches one or more suspicious network traffic pattern; determine whether the network traffic on the second data path matches one or more suspicious network traffic pattern; and configure the switch to disconnect the first vSwitch based on a determination that the network traffic on the first data path matches the one or more suspicious network traffic patterns; configure the switch to disconnect the second vSwitch based on a determination that the network traffic on the second data path matches the one or more suspicious network traffic patterns; or configure the switch to disconnect both the first vSwitch and the second vSwitch based on a determination that the network traffic on the first data path and the network traffic on the second data path matches the one or more suspicious network traffic patterns.

Example 21. The computer-readable storage medium of example 15, wherein the vSwitch is communicatively connected to the network connection of the host device, the instructions when executed by the circuitry cause the host device to: monitor network traffic on a data path between the vSwitch and the switch; determine whether network traffic matches one or more suspicious network traffic pattern; and configure the switch to disconnect the vSwitch from the network connection based on a determination that the network traffic matches the one or more suspicious network traffic patterns.

Example 22. An apparatus, comprising: means for identifying, at a root partition of a host device, a network connection of the host device; means for identifying, at the root partition, a virtual machine (VM) executing on the host device; means for receiving a VM network access configuration; and means for configuring a switch to communicatively connect or disconnect a virtual switch (vSwitch) associated with the VM with the network connection of the host device.

Example 23. The apparatus of example 22, the VM a first VM and the vSwitch a first vSwitch, the apparatus comprising: means for identifying, at the root partition, a second VM executing on the host device; and means for configuring the switch to communicatively connect or disconnect a second vSwitch associated with the second VM with the network connection of the host device independently of the first vSwitch.

Example 24. The apparatus of example 23, comprising: means for determining whether the first VM is authorized to access the network connection of the host device based on the VM network access configuration; and means for configuring the switch to communicatively connect the first vSwitch with the network connection of the host device based on a determination that the first VM is authorized to access the network connection of the host device; or configuring the switch to communicatively disconnect the first vSwitch with the network connection of the host device based on a determination that the first VM is not authorized to access the network connection of the host device.

Example 25. The apparatus of example 24, comprising: means for determining whether the second VM is authorized to access the network connection of the host device based on the VM network access configuration; and means for configuring the switch to communicatively connect the second vSwitch with the network connection of the host device based on a determination that the second VM is authorized to access the network connection of the host device; or means for configuring the switch to communicatively disconnect the second vSwitch with the network connection of the host device based on a determination that the second VM is not authorized to access the network connection of the host device.

Example 26. The apparatus of example 25, comprising: means for identifying a characteristic of the network connection of the host device; and means for determining whether the first VM is authorized to access the network connection of the host device based on the identified characteristic of the network connection.

Example 27. The apparatus of example 25, wherein the first vSwitch and the second vSwitch are communicatively connected to the network connection of the host device, the apparatus comprising: means for monitoring network traffic on a first data path between the first vSwitch and the switch; means for monitoring network traffic on a second data path between the second vSwitch and the switch; means for determining whether network traffic on the first data path matches one or more suspicious network traffic pattern; means for determining whether the network traffic on the second data path matches one or more suspicious network traffic pattern; and means for configuring the switch to disconnect the first vSwitch based on a determination that the network traffic on the first data path matches the one or more suspicious network traffic patterns; means for configuring the switch to disconnect the second vSwitch based on a determination that the network traffic on the second data path matches the one or more suspicious network traffic patterns; or means for configuring the switch to disconnect both the first vSwitch and the second vSwitch based on a determination that the network traffic on the first data path and the network traffic on the second data path matches the one or more suspicious network traffic patterns.

Example 28. The apparatus of example 22, wherein the vSwitch is communicatively connected to the network connection of the host device, the apparatus comprising: means for monitoring network traffic on a data path between the vSwitch and the switch; means for determining whether network traffic matches one or more suspicious network traffic pattern; and means for configuring the switch to disconnect the vSwitch from the network connection based on a determination that the network traffic matches the one or more suspicious network traffic patterns.

What is claimed is:

1. A method, comprising:
identifying, at a root partition of a host device, a network connection of the host device;
identifying, at the root partition, a virtual machine (VM) executing on the host device;
receiving a VM network access configuration; and
configuring a switch to communicatively connect or disconnect a virtual switch (vSwitch) associated with the VM with the network connection of the host device.

2. The method of claim 1, the VM a first VM and the vSwitch a first vSwitch, the method comprising:
identifying, at the root partition, a second VM executing on the host device; and
configuring the switch to communicatively connect or disconnect a second vSwitch associated with the second VM with the network connection of the host device independently of the first vSwitch.

3. The method of claim 2, configuring the switch to communicatively connect or disconnect the first vSwitch associated with the first VM with the network connection of the host device comprising:
determining whether the first VM is authorized to access the network connection of the host device based on the VM network access configuration; and
configuring the switch to communicatively connect the first vSwitch with the network connection of the host device based on a determination that the first VM is authorized to access the network connection of the host device; or
configuring the switch to communicatively disconnect the first vSwitch with the network connection of the host device based on a determination that the first VM is not authorized to access the network connection of the host device.

4. The method of claim 3, configuring the switch to communicatively connect or disconnect the second vSwitch associated with the second VM with the network connection of the host device comprising:
determining whether the second VM is authorized to access the network connection of the host device based on the VM network access configuration; and
configuring the switch to communicatively connect the second vSwitch with the network connection of the host device based on a determination that the second VM is authorized to access the network connection of the host device; or
configuring the switch to communicatively disconnect the second vSwitch with the network connection of the host device based on a determination that the second VM is not authorized to access the network connection of the host device.

5. The method of claim 4, determining whether the first VM is authorized to access the network connection of the host device based on the VM network access configuration comprising:
identifying a characteristic of the network connection of the host device; and
determining whether the first VM is authorized to access the network connection of the host device based on the identified characteristic of the network connection.

6. The method of claim 4, wherein the first vSwitch and the second vSwitch are communicatively connected to the network connection of the host device, the method comprising:
monitoring network traffic on a first data path between the first vSwitch and the switch;
monitoring network traffic on a second data path between the second vSwitch and the switch;
determining whether network traffic on the first data path matches one or more suspicious network traffic pattern;
determining whether the network traffic on the second data path matches one or more suspicious network traffic pattern; and
configuring the switch to disconnect the first vSwitch based on a determination that the network traffic on the first data path matches the one or more suspicious network traffic patterns;
configuring the switch to disconnect the second vSwitch based on a determination that the network traffic on the second data path matches the one or more suspicious network traffic patterns; or
configuring the switch to disconnect both the first vSwitch and the second vSwitch based on a determination that the network traffic on the first data path and the network traffic on the second data path matches the one or more suspicious network traffic patterns.

7. The method of claim 1, wherein the vSwitch is communicatively connected to the network connection of the host device, the method comprising:
monitoring network traffic on a data path between the vSwitch and the switch;
determining whether network traffic matches one or more suspicious network traffic pattern; and
configuring the switch to disconnect the vSwitch from the network connection based on a determination that the network traffic matches the one or more suspicious network traffic patterns.

8. A computing apparatus comprising:
a processor of a host device; and
memory at the host device storing instructions that, when executed by the processor, configure the host device to:
identify, at a root partition of the host device, a network connection of the host device;
identify, at the root partition, a virtual machine (VM) executing on the host device;
receive a VM network access configuration; and
configure a switch to communicatively connect or disconnect a virtual switch (vSwitch) associated with the VM with the network connection of the host device.

9. The computing apparatus of claim 8, the VM a first VM and the vSwitch a first vSwitch, the instructions when executed by the processor configured the host device to:
identify, at the root partition, a second VM executing on the host device; and
configure the switch to communicatively connect or disconnect a second vSwitch associated with the second VM with the network connection of the host device independently of the first vSwitch.

10. The computing apparatus of claim 9, the instructions when executed by the processor configured the host device to:
determine whether the first VM is authorized to access the network connection of the host device based on the VM network access configuration; and
configure the switch to communicatively connect the first vSwitch with the network connection of the host device based on a determination that the first VM is authorized to access the network connection of the host device; or
configure the switch to communicatively disconnect the first vSwitch with the network connection of the host device based on a determination that the first VM is not authorized to access the network connection of the host device.

11. The computing apparatus of claim 10, the instructions when executed by the processor configured the host device to:
determine whether the second VM is authorized to access the network connection of the host device based on the VM network access configuration; and
configure the switch to communicatively connect the second vSwitch with the network connection of the host device based on a determination that the second VM is authorized to access the network connection of the host device; or
configure the switch to communicatively disconnect the second vSwitch with the network connection of the host device based on a determination that the second VM is not authorized to access the network connection of the host device.

12. The computing apparatus of claim 11, the instructions when executed by the processor configured the host device to:
identify a characteristic of the network connection of the host device; and
determine whether the first VM is authorized to access the network connection of the host device based on the identified characteristic of the network connection.

13. The computing apparatus of claim 11, wherein the first vSwitch and the second vSwitch are communicatively connected to the network connection of the host device, the instructions when executed by the processor configured the host device to:
monitor network traffic on a first data path between the first vSwitch and the switch;
monitor network traffic on a second data path between the second vSwitch and the switch;
determine whether network traffic on the first data path matches one or more suspicious network traffic pattern;
determine whether the network traffic on the second data path matches one or more suspicious network traffic pattern; and
configure the switch to disconnect the first vSwitch based on a determination that the network traffic on the first data path matches the one or more suspicious network traffic patterns;
configure the switch to disconnect the second vSwitch based on a determination that the network traffic on the second data path matches the one or more suspicious network traffic patterns; or
configure the switch to disconnect both the first vSwitch and the second vSwitch based on a determination that the network traffic on the first data path and the network traffic on the second data path matches the one or more suspicious network traffic patterns.

14. The computing apparatus of claim 8, wherein the vSwitch is communicatively connected to the network connection of the host device, the instructions when executed by the processor configured the host device to:
monitor network traffic on a data path between the vSwitch and the switch;
determine whether network traffic matches one or more suspicious network traffic pattern; and
configure the switch to disconnect the vSwitch from the network connection based on a determination that the network traffic matches the one or more suspicious network traffic patterns.

15. A non-transitory computer-readable storage medium, the computer-readable storage medium including instructions that when executed by circuitry of a host device, cause the host device to:
identify, at a root partition of the host device, a network connection of the host device;
identify, at the root partition, a virtual machine (VM) executing on the host device;
receive a VM network access configuration; and
configure a switch to communicatively connect or disconnect a virtual switch (vSwitch) associated with the VM with the network connection of the host device.

16. The computer-readable storage medium of claim 15, the VM a first VM and the vSwitch a first vSwitch, the instructions when executed by the circuitry cause the host device to:
identify, at the root partition, a second VM executing on the host device; and
configure the switch to communicatively connect or disconnect a second vSwitch associated with the second VM with the network connection of the host device independently of the first vSwitch.

17. The computer-readable storage medium of claim 16, the instructions when executed by the circuitry cause the host device to:
determine whether the first VM is authorized to access the network connection of the host device based on the VM network access configuration; and
configure the switch to communicatively connect the first vSwitch with the network connection of the host device based on a determination that the first VM is authorized to access the network connection of the host device; or
configure the switch to communicatively disconnect the first vSwitch with the network connection of the host device based on a determination that the first VM is not authorized to access the network connection of the host device.

18. The computer-readable storage medium of claim 17, the instructions when executed by the circuitry cause the host device to:
determine whether the second VM is authorized to access the network connection of the host device based on the VM network access configuration; and
configure the switch to communicatively connect the second vSwitch with the network connection of the host device based on a determination that the second VM is authorized to access the network connection of the host device; or
configure the switch to communicatively disconnect the second vSwitch with the network connection of the host device based on a determination that the second VM is not authorized to access the network connection of the host device.

19. The computer-readable storage medium of claim 18, the instructions when executed by the circuitry cause the host device to:
identify a characteristic of the network connection of the host device; and
determine whether the first VM is authorized to access the network connection of the host device based on the identified characteristic of the network connection.

20. The computer-readable storage medium of claim 18, wherein the first vSwitch and the second vSwitch are communicatively connected to the network connection of the host device, the instructions when executed by the circuitry cause the host device to:
monitor network traffic on a first data path between the first vSwitch and the switch;
monitor network traffic on a second data path between the second vSwitch and the switch;
determine whether network traffic on the first data path matches one or more suspicious network traffic pattern;
determine whether the network traffic on the second data path matches one or more suspicious network traffic pattern; and
configure the switch to disconnect the first vSwitch based on a determination that the network traffic on the first data path matches the one or more suspicious network traffic patterns;
configure the switch to disconnect the second vSwitch based on a determination that the network traffic on the second data path matches the one or more suspicious network traffic patterns; or
configure the switch to disconnect both the first vSwitch and the second vSwitch based on a determination that the network traffic on the first data path and the network traffic on the second data path matches the one or more suspicious network traffic patterns.

21. The computer-readable storage medium of claim 15, wherein the vSwitch is communicatively connected to the network connection of the host device, the instructions when executed by the circuitry cause the host device to:
monitor network traffic on a data path between the vSwitch and the switch;
determine whether network traffic matches one or more suspicious network traffic pattern; and
configure the switch to disconnect the vSwitch from the network connection based on a determination that the network traffic matches the one or more suspicious network traffic patterns.
